(19) United States
(12) Patent Application Publication
(10) Pub. No.: US 2025/0326128 A1
(43) Pub. Date: Oct. 23, 2025

(54) INTEGRATED ROBOTIC CONTROLLER

(71) Applicant: Dexterity, Inc., Redwood City, CA (US)

(72) Inventors: Zhouwen Sun, San Mateo, CA (US); Samir Menon, Atherton, CA (US); Gil Matzliach, Sunnyvale, CA (US)

(21) Appl. No.: 19/182,468

(22) Filed: Apr. 17, 2025

Related U.S. Application Data
(60) Provisional application No. 63/636,580, filed on Apr. 19, 2024.

(51) Int. Cl. B25J 9/16; B25J 5/00; B25J 9/08; B25J 13/08; B65G 67/02

(52) U.S. Cl. CPC B25J 9/1697; B25J 9/08; B25J 13/085; B25J 5/007; B65G 67/02; G05B 2219/33221; G05B 2219/39001; G05B 2219/39251

(57) ABSTRACT

An integrated robotic controller is disclosed which includes a communication interface configured to provide connectivity to a set of elements comprising a robotic system and a processor coupled to the communication interface and configured to: receive state information via the communication interface from or more elements included in the set of elements; make based at least in part on the state information a decision as to how to control one or more elements included in the set of elements; and send to each of the one or more elements, via the communication interface, a command determined based on at least in part on the decision.

### CROSS REFERENCE TO OTHER APPLICATIONS

This application claims priority to U.S. Provisional Patent Application No. 63/636,580 entitled INTEGRATED ROBOTIC CONTROLLER filed Apr. 19, 2024 which is incorporated herein by reference for all purposes.

### BACKGROUND OF THE INVENTION

A modern robotic system and operation typically involves a variety of hardware and software components, which are used in concert to operate one or more robots to perform tasks to achieve an operational objective.

For example, in a warehouse or other logistics context, one or more robots may be used to load/unload trucks or other containers, stack items on a pallet or remove them from a pallet, assemble dissimilar items into boxes or bins, retrieve items from and/or place them on a shelf or other receptacle, perform singulation/sortation, etc.

To perform such tasks, robotic arms equipped with a variety of grippers, autonomous mobile robots, automated guided robots, etc., and other robots may be used in cooperation to move materials between work locations; and/or other robots may be used in connection with cameras, sensors, safety equipment and subsystems, lighting systems, material handling equipment, etc.

In a typical system, a control computer communicates via a network connection with a robot controller included with a specific piece of commodity hardware, such as a robotic arm. The robot controller provides signals to the motor controllers associated with the robot's joints to cause the robotic arm to be moved as needed to perform a task.

The control computer may receive input from one or more cameras and may use computer vision to maintain a view of the workspace. Sensor readings may be used to determine how to control the robot, via the robot controller. For example, readings from force sensors on the robot may be used to detect that an obstacle has been encountered or to snug an item into place to achieve greater stability or more dense packing.

Reliance on a robot controller provided with commodity hardware limits flexibility and may result in the robot being used less than to its full potential. Further, the latency associated with camera and other sensor data being sent to and processed by a control computer and then commands reflecting decisions made by the control computer being sent to the robotic controller may result in delays or errors.

### BRIEF DESCRIPTION OF THE DRAWINGS

Various embodiments of the invention are disclosed in the following detailed description and the accompanying drawings.

FIG. 1A is a diagram illustrating an embodiment of an extensible robotic system.

FIG. 1B is a diagram illustrating an embodiment of an extensible robotic system.

FIG. 2A is a block diagram illustrating an embodiment of an extensible robotic system.

FIG. 2B is a block diagram illustrating an embodiment of an integrated robotic controller.

FIG. 3 illustrates an embodiment of a robotic system with an integrated robotic controller.

FIG. 4 is a flow diagram illustrating an embodiment of a process to incorporate a new element into a robotic control domain.

FIG. 5 is a block diagram illustrating an embodiment of an integrated robotic controller.

FIG. 6 is a state diagram illustrating control states and transitions between them in an embodiment of an integrated robotic controller.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A robotic controller configured to receive inputs, process information, make decisions, and generate control signals close to the robotic element being controlled is disclosed. In various embodiments, processing previously performed by a robotic software application running on a control computer and/or by the control computer itself (or an integrate or associated decision-making engine) are instead made (when possible) closer to the robot being controlled.

In various embodiments, a robotic controller as disclosed herein makes decisions in real time as to how the joints and associated motors comprising a robotic arm, for example, will be activated to move the joints and links comprising the robot and/or operate the suction or other gripping functionality of a gripper mounted on the arm are used to perform a task, such as to pick and place an item.

In various embodiments, a robotic controller as disclosed herein comprises an artificial intelligence powered computing platform. The computing platform provides access to and coordinates invocation and use of a set of skills of the robotic element controlled by the robotic controller and, in some embodiments, other elements comprising a robotic system. Examples of skills including, without limitation, how to pick, how to place, how to move, stack, manage fleets, have robots use one arm or two arms, suction grippers or grabbing grippers, etc. For different robotics applications, the respective skill sets may overlap, but each set may include skills specific to the application.

For example, a robotic system used to perform singulation/sortation must be able to pick and place items, and those skills also would be required to stack items on a pallet or in a truck, etc.

The computing platform may include and/or use a variety of ancillary modules required for the skills to work. Examples of such modules include computer vision, motion planning, collision avoidance, simulation, etc.

The computing platform may be used in connection with a decision engine comprising software configured to invoke skills made available via the computing platform, in specific ways and in a determined sequence and timing, to cause robotic elements, such as a robotic arm and gripper, to be used to perform tasks in a sequence and manner that achieves an objective, such as to unload items from a truck, or stack items on a pallet, etc. In some cases, the decision engine may be integrated into the computer platform and/or otherwise incorporated into the robotic controller.

One or more robotics applications may be run on top of the decision engine and/or the computing platform. A robotics application may comprise code associated with the performance of a specific type of operation, such as palletization/depalletization, truck/container loading/unloading, sortation/singulation, shelf kitting, line kitting, etc. A single application may comprise code to implement a variety of robotics applications (use cases), or separate applications may be defined for each robotics application (use case), e.g., one for singulation, one or palletization/depalletization, etc.

In some embodiments, an application framework, runtime, software development kit (SDK), API, etc., may be provided, to enable a third-party developer to develop an application to run on the decision engine and/or computing platform. The application may invoke and use previously-defined skills and/or the third-party developer may define and use new skills, e.g., skills that invoke and combine lower-level primitives exposed by the computing platform to cause the robotic arm or other robotic instrumentality to exhibit a desired behavior (skill).

In some embodiments, one or more of the application(s), decision engine, and computing platform are integrated into a single entity and/or implemented on a robotics controller as disclosed herein.

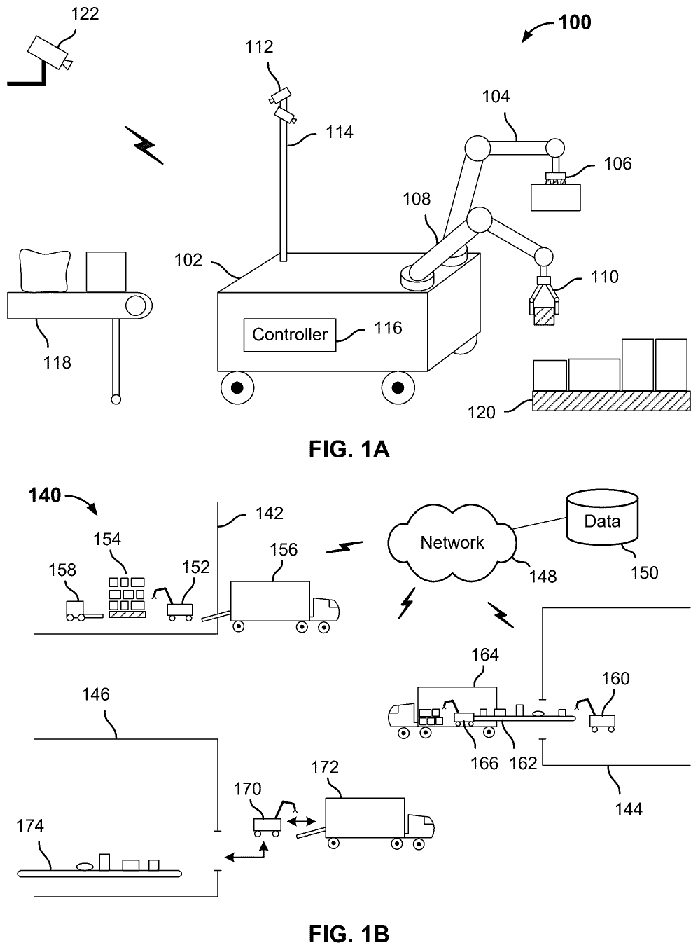

FIG. 1A is a diagram illustrating an embodiment of an extensible robotic system. In the example shown, system 100 includes a mobile base 102 on which robotic arm 104 with suction type end effector 106 and robotic arm 108 with gripper style end effector 110 are mounted. Cameras 112 are mounted on mobile base 102 via a pole or other superstructure 114.

The system 100 is shown in FIG. 1A to be engaged in palletization or depalletization, e.g., picking items from conveyor 118 and stacking them on pallet 120 or vice versa.

In the example shown, mobile base 102 includes a controller 116 configured to operate mobile base 102 autonomously or semi-autonomously, e.g., to navigate from a start location into the work location as shown. Controller 116 may be configured to control the robotic arms 104, 108 and/or end effectors 106, 110, directly or indirectly. For example, controller 116 may control the robotic arms 104, 108 directly, e.g., by sending torque commands to motor controllers for the respective joints comprising the robotic arms 104, 108 or indirectly, e.g., by sending commands to robotic arm controllers comprising the robotic arms 104, 108.

In various embodiments, controller 116 may be configured to perform a robotic application, such as palletization/depalletization, such as by invoking or installing a robotic application that runs on a framework or environment supported and/or provided on controller 116. Controller 116 may be commanded, configured, etc. to perform the application via wireless communications, e.g., from a central and/or peer node with which controller 116 is configured to communicate, e.g., via local wireless communications, network communications, etc.

In various embodiments, controller 116 may be configured to communicate with other elements comprising the system 100, e.g., robotic arms 104, 108 according to a proprietary, standards-based, negotiated, and/or otherwise determined protocol. Controller 116 may be configured to operate the wheels of mobile base 102; robotic arms 104, 108; and/or end effectors 106, 110 synchronously to pick items from conveyor 118 and stack them on pallet 120, for example.

In the example shown, system 100 includes a camera 122 installed in the workspace. Controller 116 may be configured to control one or more of the onboard cameras 112 and camera 122 as needed to perform the robotic palletization/depalletization task it has been assigned. For example, controller 116 may control the frame rate, resolution, optical focus, pan/tilt, and/or other aspects of the operation of the cameras 112, 122 as/if need to (better) perform its assigned work. For example, one or more cameras may be turned off when not needed, to conserve electricity and/or battery life. A camera may be switched to a higher frame rate, narrower field of view, etc., such as to enable the system to “concentrate” more closely on a fine or difficult task, such as pushing an item into place or navigating through a tough space.

In some embodiments, controller 116 and/or another controller comprising the system 100 may be configured to control operation of conveyor 118, e.g., to change the speed as required or supported by the pick/place throughput of the system.

In various embodiments, controller 116 may be configured to track and report to a remote node usage statistics for one or more of the elements comprising system 100, such as robotic arms 104, 108 and/or end effectors 106, 110. The usage data may be tracked to plan maintenance, predict failures, schedule repair or replacement, etc.

FIG. 1B is a diagram illustrating an embodiment of an extensible robotic system. In the example shown system 140 is distributed across multiple sites comprising a wide area, including in this example warehouse and/or distribution center sites 142, 144, and 146. At each site, robotic and auxiliary equipment (cameras, sensors, material handling, safety systems and components, etc.) comprising an integrated robotics system, distributed over a wide area, operate autonomously and/or semi-autonomously to perform tasks associated with one or more robotic applications to accomplish a high level objective, such as to load or unload a truck; remove items from a pallet or stack them on a pallet; move items within a site to a shelf or other storage location; place items in or on a shelf or other storage location; retrieve items from a shelf or other storage location; place items in boxes or other containers for shipment; etc.

In various embodiments, robotic and auxiliary equipment (cameras, sensors, material handling, safety systems and components, etc.) comprising an integrated robotics system, may be distributed over a wide area, as in the example shown in FIG. 1B.

In the example shown in FIG. 1B, elements comprising system 140 communicate with each other and/or with other nodes, not shown in FIG. 1B, via network 148. Database 150 maybe used to store robotic applications; logistical information (e.g., where elements are located); configuration information (e.g., which elements are positioned at which sites, what are their respective capabilities, etc.); and operational information (e.g., invoices, manifests, or other information as to which items or sets of items are located where, to which destination is each item bound, etc.).

In some embodiments, database 150 may store a repository of learned information, such as skills learned by one or more elements at a first site which are then communicated via network 148, stored in database 150, and later communicated via network 148 to one or more other elements comprising system 140. In this way, lessons learned at one site or by one element of the system 140 may be shared with other elements and later used to perform similar tasks.

In the example shown in FIG. 1B, site 142 includes a mobile logistics robot 152, e.g., similar to the robot 102, 104, 106, 108, 110 of FIG. 1A, configured to take items from pallet 154 and load them into truck 156. In this example, a robotic forklift 158 (e.g., an autonomous guided vehicle or AGV) is shown to have placed the pallet 154 in position. The elements shown and/or other elements comprising system 140 may have tasked the elements at site 142 to load the items into truck 156.

At site 144, mobile logistics robot 160 is shown to be picking items from a conveyor 162 that is extended into truck 164. A second mobile logistics robot 166 is shown to have entered the truck 164 to unload the truck 164 by picking items from the truck and placing them one by one onto conveyor 162. In various embodiments, one or more elements comprising system 140 at site 144 may control the conveyor 162, e.g., to position the conveyor 162 in truck 164, move it further into truck 164 as it is unloaded, control the direction and speed of conveyor 162 according to throughput, etc.

At site 146, mobile logistics robot 170 is shown to be shuttling items between truck 172 and conveyor 174 in the warehouse or distribution center of site 146, e.g., to load or unload truck 172.

At all sites 142, 144, 146, elements comprising system 140 may be configured to report their respective location, status, workload, availability, usage statistics, etc., e.g. via network 148 for storage in database 150.

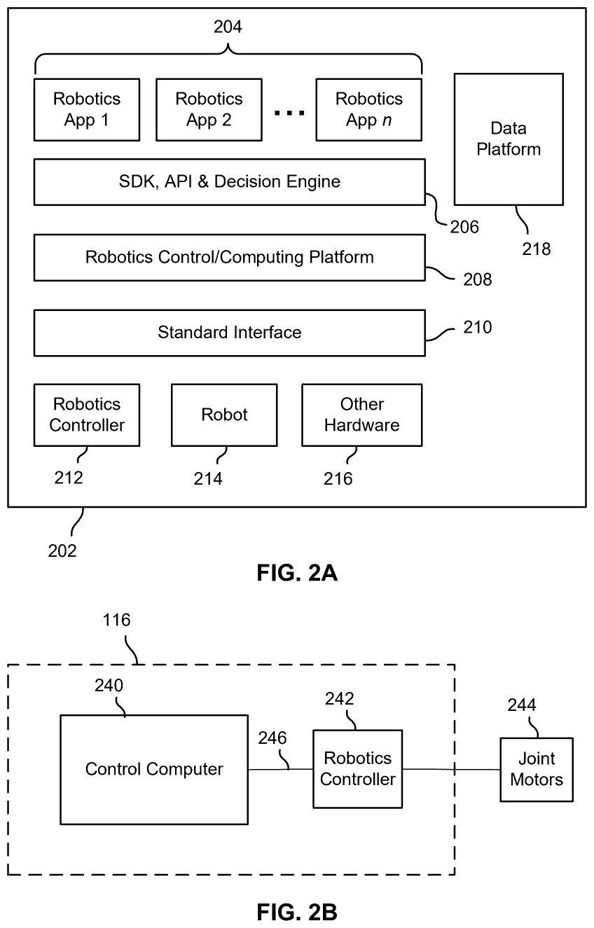

FIG. 2A is a block diagram illustrating an embodiment of an extensible robotic system. In the example shown, controller 202 embodies a software stack/architecture used in various embodiments to provide an extensible robotic system, as disclosed herein. As shown, controller 202 includes a plurality of robotics applications 204 (e.g., truck load/unload, palletization/depalletization, kitting, singulation, sortation, etc.) running via a software development kit (SDK), application programming interface (API), and/or Decision Engine 206 on a robotics control/computing platform 208. Commands to cause robotically controlled elements are communicated via standard interface 210 to one or more robotics controllers 212 (e.g., controller 116 of FIG. 1A), robots 214, and/or other hardware 216 (e.g., cameras, material handling equipment, etc.)

In various embodiments, the robotics controller in FIG. 2A may control a robotic platform and/or other robotic elements, such as one or more robotic arms, and/or other elements, such as material handling equipment or other auxiliary equipment, cameras and other sensors, safety system components, etc.

In various embodiments, the computing platform and/or layers above it may communicate with any compatible hardware or software component, such as a compatible robot or robotics platform, via a standard interface, such as standard interface 210. The standard interface may be a private or public (e.g., API, published, and/or open interface), which defines a communication protocol, syntax, grammar, etc. to enable standard-compliant computing platforms and/or robotics system components (robots, other actuators, cameras, other sensors, material handling equipment and/or other auxiliary equipment, etc.) to communicate about needs, conditions, context, resources, skills, requirements, etc.

Referring further to FIG. 2A, in the example shown one or more robotics applications 204, platform 208, robotics controller(s) 212, robot(s) 214, and other hardware 216 may communicate information such as equipment status, usage statistics, etc. via data platform 218 and/or may obtain data via data platform 218, such as configuration data, strategies learned by other elements to perform certain tasks, etc.

In various embodiments, the modules/layers shown in FIG. 2A comprise an extensible systemwide architecture, many instances of which may exist, each associated with a set of one or more elements comprising an extensible robotic system as disclosed here.

In various embodiments, elements comprising a system as disclosed herein may be added or removed dynamically (e.g., plug and play). Techniques disclosed herein may be used to maintain trust/security, establish and maintain communications/connectivity, learn and use capabilities (skills), etc.

In various embodiments, a new element (hardware, software, combination of hardware and software) may be added to a robotics system, the elements of which may be local or distributed over a wide area, such as the robotics system elements of a large enterprise having operations at multiple physical locations.

A new element is connected and announces itself via a standard protocol. One or more elements comprising the system may allow a connection to determine if trust can be established. Trust may be based on one or more of a configured credential, such as a cryptographically signed certificate, a shared secret, a vendor or equipment identifier, etc. Once trusted, the capabilities (skills), context (e.g., geographic location), and requirements of the new element may be determined. For example, standards-based codes or other shorthand may be used to communicate a new element's capabilities, context, and requirements to other elements comprising the system. Once connected and understood, a newly added element may be included in decision-making and operation of the system.

In various embodiments, elements comprising a robotic system as disclosed herein may be added or removed dynamically (e.g., plug and play). A controller as disclosed herein may be configured to implement standards-based protocols to establish and maintain trust/security, provide secure communications, learn and use capabilities (skills), etc.

FIG. 2B is a block diagram illustrating an embodiment of an integrated robotic controller. In various embodiments, the control architecture of FIG. 2B may be used to provide an integrated robotic controller as disclosed herein, e.g., the controller 116 of FIG. 1A. In the example shown in FIG. 2B, controller 116 is shown to include control computer 240, which may be a general purpose or special purpose computer. Control computer 240 may comprise a computer or other processor mounted on or in the chassis of robot 102, for example. In various embodiments, control computer 240 may include one or more of the functions and/or modules shown in FIG. 2A, excluding the robotic controller 212, robot 214, and other hardware 216.

The controller 116 is shown in FIG. 2B to further include one or more robotic controllers 242. For example, the robot 102 of FIG. 1A may include a single controller 242 configured to control the mobile chassis of robot 102 and the robotic arms 104, 108 and their end effectors 106, 110. Alternatively, the robot 102 may include a separate controller 242 for the mobile chassis and each of the robotic arms 104, 108, all controlled by a single control computer 240.

In various embodiments, the controller 242 may be a relatively small printed circuit board (PCB) or even a single chip, as compared to a robotic controller typically include by an original equipment manufacturer (OEM) (i.e., make and/or vendor) of a robotic arm or other robotic equipment. Each controller 242 controls and supplies current to one or more joint motors, e.g., by providing commands and/or control voltages to respect joint motor drivers, which amplify the control voltage (or respond to the command) to supply the current required to drive the motor and thereby apply a corresponding torque at the joint.

In various embodiments, the architecture shown in FIG. 2B facilitates effective torque control. For example, sensors (e.g., force/torque sensors) not shown in FIG. 2B may generate torque signals provided to control computer 240 and/or robotics controller 242 may be used as feedback to create a closed loop of control. Controller 242 may supply a command, control voltage, and/or current to a joint motor driver 244 to achieve a desired torque, receive feedback as to whether the desired torque is being achieved, and if not can increase or decrease the current being supplied to the motor, which translates into a change in torque.

In various embodiments, the communication interface or link 246 between control computer 240 and (each) controller 242 comprises an EtherCAT or similar link, e.g., another field bus protocol connection, capable of high-speed communication of control information. For example, in some embodiments, link 246 comprises an EtherCAT link running at 8,000 cycles/second and capable of transmitting/receiving a command within one or two cycles (i.e., 1/8000th or 1/4000th of a second). Each cycle, 100 to 200 or more values may be communicated between control computer 240 and controller 242.

In various embodiments, image data from one or more cameras; sensor data from force/torque sensors, LIDAR, or other sensors; current readings for a current sensor; temperature sensors; etc. may be received by control computer 240 and used to control aspects of the robotic system.

OEM-provided controllers typically include both the control logic and the circuitry to supply control signals and/or voltages and current to the motors comprising the robotic arm or other robot, e.g., on a single PCB or a set of interconnected PCBs. The control logic in such a controller typically is limited to what the OEM chooses to include. By contrast, the architecture shown in FIG. 2B enables the control computer 240 to be programmed in more varied and/or sophisticated ways, e.g., by running different robotic applications, as in the architecture shown in FIG. 2A. The control computer 240 similarly may comprise the kinematic and other models used to control a robotic arm or other robot and may determine and provide to controller 242 lower level and/or efficiently encoded low level commands, e.g., indicating how much current to supply to each respective motor and in which sequence.

Typically, an OEM controller provides for carefully constrained operations and includes built in safeguards to protect the robot, e.g., to prevent damage to motors from excessive torque, etc. If the robot is operated within the constraints, it may be rare to receive a warning or error message except in the case of an actual equipment failure or other occurrence potentially requiring human operator intervention. In various embodiments, an integrated controller as disclosed herein may not operate within the same constraints as the OEM and/or may receive and interpret sensor readings independently of the OEM's controller or other OEM equipment. In various embodiments, an integrated controller as disclosed herein responds dynamically and intelligently to sensor data that may or may not be associated with an equipment failure. For example, a robotic controller as disclosed herein may detect a potential error or failure condition, such as motor torque exceeding a certain threshold. An OEM controller might, in response to such a signal, perform an emergency stop and require human intervention to reset the warning and restart the system. By contrast, in various embodiments, a controller as disclosed herein may first command the robot to move to a known safe position and/or pose. If the robot is able to comply, the controller will know the robot is operational despite the high torque reading. The system may use vision, temperature, or other sensors, along with an artificial intelligence and/or machine learning based knowledge of past failure conditions, to determine that the robot is capable to resume operation. Vision or other sensors may be used to make and implement a plan to resume the task that was interrupted. For example, an obstacle may be seen in the workspace, and the system may make a new plan to move around the obstacle to complete the task that was interrupted.

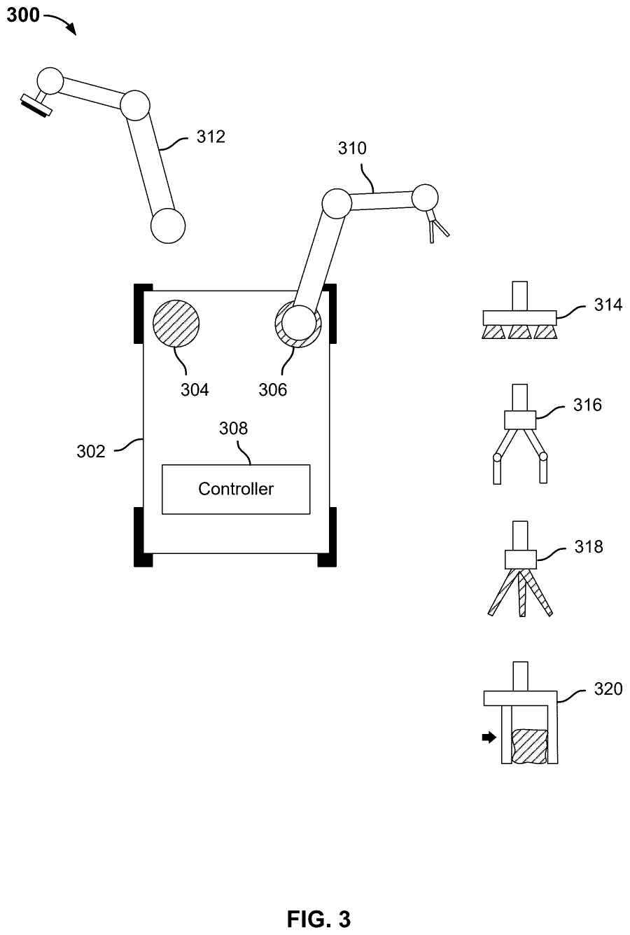

FIG. 3 illustrates an embodiment of a robotic system with an integrated robotic controller. In the example shown, robotic system 300 includes a mobile chassis 302, controlled by the robotic controller 308, and mounting points 304, 306 for two robotic arms 310, 312. Robotic arm 312 is shown in a dismounted position. In various embodiments, robotics arms such as robotic arms 310, 312 may be mounted or dismounted from mounting points 304, 306, as/if needed, e.g., to mount a robotic arm have different dimensions, capacity, or other attributes and/or capabilities.

In various embodiments, the arms 310, 312 and/or end effectors attached thereto may be changed or interchangeable. For example, robotic arm 310 is shown with a gripper style end effector while robotic arm 312 is shown with a suction pad type gripper. Alternative grippers may be available to be mounted on the robotic arms 310, 312, such as the suction cup style gripper 314, articulated finger gripper 316, three finger gripper 318, and variable width gripper 320, the latter of which may include a linear actuator to move a mobile side panel nearer to a stationary side panel, as shown, to grip in item.

In various embodiments, a robotic controller as disclosed herein may control the changing of the hardware and/or may recognize that such a change has occurred (e.g., via manual intervention and reconfiguration by a human), establish trust and secure communication with the new component, and integrate its capabilities into its operations.

In various embodiments, plug and play capability is provided. A new element (hardware, software, combination of hardware and software) may be added to a robotics system, the elements of which may be local or distributed over a wide area, such as the robotics system elements of a large enterprise having operations at multiple physical locations. In various embodiments, an integrated controller as disclosed herein, such as robotic controller 308, may be configured to determine its role with respect to an added element. For example, the robotics controller 308 may determine that it is to integrate the new element into the local system that the robotics controller 308 controls, such as new arm mounted on mounting points 304, 306 or a new end effector mounted on or by robotic arms 310, 312. In some embodiments, the robotic controller 308 may act as an intermediary to report to a remote central node, such as database 150 of FIG. 1B, that a new hardware (robotic or auxiliary equipment) or software component has been added or installed at its local system, including its identity, capabilities, requirements, etc., as/if known. In some embodiments, robotics controller 308 may query a central database, such as database 150 of FIG. 1B, to determine the capabilities and requirements of a newly added element. The robotics controller 308 may integrate the new element into local operations based on information learned in response to such a query.

In various embodiments, a robotic controller as disclosed herein makes plans, schedules, and other decisions made by a separate control computer, in a typical prior art system. For example, in various embodiments, a controller as disclosed herein makes decisions in real time as to how the joints and associated motors comprising a robotic arm, for example, will be activated to move the joints and links comprising the robot and/or operate the suction or other gripping functionality of a gripper mounted on the arm are used to perform a task, such as to pick and place an item. Previously, a control computer may have initiated such changes, e.g., based on image or other sensor data available to the control computer. The robotic controller in a typical system may receive from the control computer commands instructing the robotic controller to adjust behavior of the robotic arm and/or other instrumentality. In an integrated robotic controller as disclosed herein, by contrast, the robotic controller may receive image or other sensor data, e.g., in a format and/or at a rate controlled by the robotic controller, or alerts or more specific information generated by a safety system, and may use such data to make and implement decisions about how to respond, such as by increasing the torque applied to one or more joint motors to better handle an unexpectedly heavy load, avoid an unexpected obstacle, etc. In another example, the controller may increase the suction or other gripping force as applied by an end effector, e.g., in response to a camera or other sensor (e.g., force, pressure) detecting that an item is slipping from the robot's grasp. By having sensor information and responsive decision-making take place at the controller, rather than an upstream computer, a robotic system as disclosed herein may be able to react more quickly and decisively to dynamic information, resulting in greater safety and efficiency, lower risk of damage to items being handled, etc.

In various embodiments, a robotic system as disclosed herein, e.g., robot 102 of FIG. 1A, may include multiple robotic instrumentalities, such as robotic arms 104, 108. In some embodiments, the robotic instrumentalities may be powered by a common (i.e., shared) DC or other power bus. An integrated controller as disclosed herein may be configured to take power management into consideration in determining how to use the different respective robotic instrumentalities (e.g., robotic arms) to do work. For example, a robotic arm or other motor driven robot may consume power to do certain work, such as lifting, but may generate power when performing certain other work, such as braking or controlled lower of a box pulled from the top of a stack or pile. For a set of tasks, such as unloading a truck, pallet, or other receptacle, a control computer and/or controller as disclosed herein may take advantage of the fact that two or more robotic arms (or other instrumentalities) are powered by the same bus to use the arms in a reciprocating fashion, e.g., one raising its end effector and/or links, consuming power from the bus, while the other lowers a load and/or its end effector and/or links, at the same time generating and adding power to the bus.

In some embodiments, an integrated robotic controller as disclosed herein may be configured to participate in managing thermal conditions. For example, a heat sink, thermal mass, or other heat transfer component may be provided on which heat generating components comprising the system may be mounted, such as control computer 240, controller 242 of FIG. 2B. Temperature sensor readings may be monitored by the control computer 240 and/or controller 242 and active cooling (e.g., air, chill water) supplied to the heat transfer component to reduce or maintain the detected temperature.

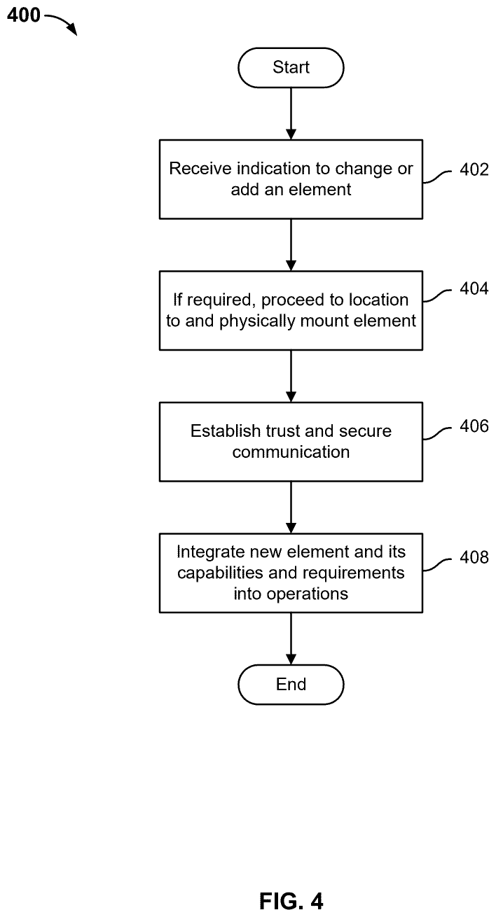

FIG. 4 is a flow diagram illustrating an embodiment of a process to incorporate a new element into a robotic control domain. In various embodiments, the process 400 of FIG. 4 may be performed by an integrated robotic controller as disclosed herein, such as robotic controller 308 of FIG. 3. In the example shown, at 402 an indication is received to change or add an element to the robotic system. For example, the controller or a higher-level control computer may have determined that a different robotic arm and/or end effector is needed or more suitable for the next task. Alternatively, new auxiliary equipment, such as a camera in the workspace, may have declared itself to be present in the workspace and available for use. At 404, if required, the robotic controller controls a robotic mobile chassis on which it is installed to navigate to a location associated with integrating the element, such as location within pairing and/or near field communication range of a new auxiliary equipment and/or a station to mount a new robotic arm and/or end effector. If applicable and required (i.e., not already mounted), the new element is physically mounted on the robotic system. At 406, trust is established, e.g., using standard authentication protocols, and secure communication with the new element is established. At 408, the new element is integrated into the operations controlled by the robotic controller. For example, the new robotic arm and/or end effector may be used under control of the robotic controller to pick/place an item.

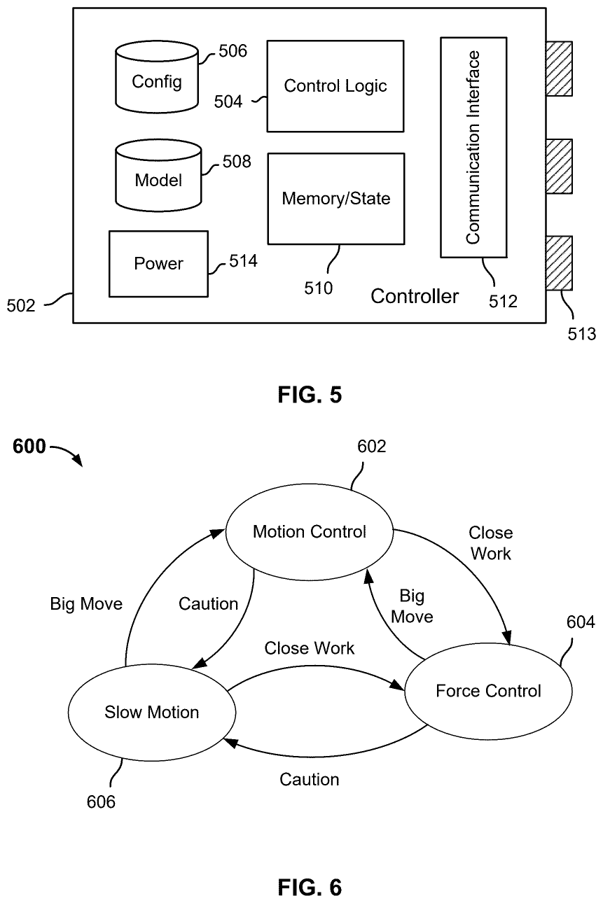

FIG. 5 is a block diagram illustrating an embodiment of an integrated robotic controller. In various embodiments, controller 502 of FIG. 5 may be used to implement the controller 308 of FIG. 3, for example. In the example shown, controller 502 includes control logic 504, may integrate and/or implement one or more of the SDK/API/Decision Engine 206, Robotics Control/Computing Platform 208, standard interface 210, and robotics controller 212 of FIG. 2.

Control logic 502 may use one or more of configuration data 506 and model data 508 to determine the configuration, capabilities, and requirements of the elements comprising the robotics system. For example, model data 508 may include a kinematic model for each connected robotic instrumentality, such as chassis 302 and/or robotic arms 310, 312 of FIG. 3. In some embodiments, model data 508 may include a generative artificial intelligence (AI) or other AI or machine learning model, which control logic 502 may use to make decisions, such as by generating and/or evaluating plans or strategies to grasp, move through a trajectory, and place an item.

Memory 510 may be used to store state information, such as a current set of objectives, tasks, and commands; a current pose and state of elements comprising the robotic system; estimated state of items stacked on a pallet or other receptacle (as in FIG. 1A, for example), etc. Commands may be sent to connected elements via communication interface 512 and the physical interface represented by pins (or other connectors) 513. In various embodiments, communication interface 512 may be configured to provide one or more of EtherCAT, serial, or other communications between the controller 502 and elements it is configured to control. Communications with other elements comprising an extended robotics system may be made via wired or wireless direct and/or network communications. The controller is powered by a power supply module 514, which may draw power from a connected battery. In some embodiments, power may be supplied to connected elements via physical connectors 513.

In various embodiments, a controller such as controller 502 may directly control associated robotic arms and/or end effectors. For example, lower-level commands may be sent directly to the respective motor controllers associated with each joint or other degree of freedom (DOF) of a robotic arm, enabling the torque applied at each joint (or other DOF) to be controlled very precisely and synchronously. Similarly, end effector suction, orientation, gripper element (e.g., digit) position, force applied, etc. may be controlled directly and precisely. Auxiliary equipment, such cameras and other sensors, may also be controlled, e.g., to ensure a camera or other sensor has a clear field of view, is pointed at a desired area of current focus, is not busy with other, lower priority work, is on/off as needed, is operating with a desired frame rate, etc. Further, material handling equipment, such as conveyors, forklifts, etc., may be controlled by the controller, e.g., via wireless communications and according to a configured and/or agreed protocol.

In various embodiments, integration of decision making (which skills to invoke and how) and control computing (how to apply motor torque at joints to perform skill) into a robot controller as disclosed herein enables decisions to be made and implemented quickly, near the instrumentality being controlled. The controller can react quickly to dynamic circumstances. The controller can move the arm and/or gripper more quickly and use dynamic braking and other techniques to avoid collisions, etc. Motion (e.g., torque) control can be used to quickly move a gripper across large distances, with force (feedback) control being used for fine adjustments. A slow-motion mode may be used if the controller senses a reason to proceed with caution, such as an approaching human.

FIG. 6 is a state diagram illustrating control states and transitions between them in an embodiment of an integrated robotic controller. In various embodiments, the state machine 600 may be implemented by an integrated robotic controller as disclosed herein, such as controller 308 of FIG. 3 or controller 502 of FIG. 5.

In the example shown, a robotic controller as disclosed herein may start in or transition at startup to a “motion control” state 602. In motion control state 602, the controller may one or more of position control, velocity control, and other control techniques based on position or higher derivatives of position (velocity, acceleration, etc.) to control robot motion.

For example, once an item to be picked and placed has been securely grasped, the controller may use motion control to move the item relatively quickly through a large portion of the planned trajectory. Once near the place location, the controller may transition to “force control” state 604. In force control state 604, the controller may use force feedback to snug or even shove an item into its final placement.

From either motion control state 602 or force control state 604, the controller may transition to “slow motion” state 606, e.g., to proceed more slowly and with high attention in response to a human worker being determined to be present or approaching, to avoid damaging an item determined to be fragile, to avoid a collision with a stationary or moving obstacle in the workspace, etc.

In various embodiments, a robot controller as disclosed herein may be connected and configured to control auxiliary equipment, such as conveyors or other material handling equipment.

For a given auxiliary equipment, a controller as disclosed herein is provided with a robust physical connection, e.g., a cable that is flexible, of adequate but not excessive length, and is routed to avoid entanglements or damage. A digital interface, such as a standards-based interface, is defined to exchange commands and information. In the case of material handling equipment, such as a conveyor, one or more of the following may be controlled:
Belt on/off
Belt direction
Belt velocity
Boom extension/retraction
Boom velocity
Boom up/down (tilt)
Position/Velocity of boom
Sensors for position feedback, camera data, etc.

In various embodiments, the capabilities, requirements, protocols supported, etc. of auxiliary equipment are described according to a standard specification. The description or a pointer or other reference to the description may be obtained from the equipment and/or looked up based on an identifier associated with the equipment. A controller as disclosed herein would use the description to determine how to integrate and use the equipment. For example, the control may assert and assume control over the equipment and may send standards-based commands to the equipment. The equipment may be natively configured to support and respond to the standards-based commands, or a hardware and/or software adapter may be provided to translate the (proprietary, open, or other) standards-based commands to values the equipment is configured to respond to.

In various embodiments, techniques disclosed herein may be used to provide an intelligent, adaptive, and distributed robotic system capable of integrating new elements dynamically and using all elements comprising the system effectively to perform tasks and achieve objectives.

Although the foregoing embodiments have been described in some detail for purposes of clarity of understanding, the invention is not limited to the details provided. There are many alternative ways of implementing the invention. The disclosed embodiments are illustrative and not restrictive.

1. A robotic controller, comprising:
a communication interface configured to provide connectivity to a set of elements comprising a robotic system; and
a processor coupled to the communication interface and configured to:
receive state information via the communication interface from or more elements included in the set of elements;
make based at least in part on the state information a decision as to how to control one or more elements included in the set of elements; and
send to each of the one or more elements, via the communication interface, a command determined based on at least in part on the decision.

2. The robotic controller of claim 1, wherein the communication interface comprises a wireless communication interface.

3. The robotic controller of claim 1, wherein the communication interface comprises an EtherCAT or serial communication interface.

4. The robotic controller of claim 1, wherein the state information is received from a camera or other sensor.

5. The robotic controller of claim 1, wherein the state information is received from a safety system.

6. The robotic controller of claim 1, wherein the set of elements includes an auxiliary equipment.

7. The robotic controller of claim 6, wherein the auxiliary equipment comprises one or more of a conveyor, a material handling equipment, a camera, a sensor, and a safety system.

8. The robotic controller of claim 1, wherein the set of elements includes an interchangeable robotic element.

9. The robotic controller of claim 8, wherein the interchangeable robotic element comprises one or both of a robotic arm and a robotic end effector.

10. The robotic controller of claim 8, wherein the processor is further configured to receive an indication that the interchangeable robotic element is to be or has been changed.

11. The robotic controller of claim 10, wherein the processor is further configured to establish trust and secure communication with a newly added robotic element that has replaced the interchangeable robotic element with respect to which the indication was received.

12. The robotic controller of claim 10, wherein the processor is further configured to integrate the newly added robotic element into work performed under control of the robotic controller.

13. The robotic controller of claim 1, wherein the decision includes for each of one or more motors associated with an element included in the set of elements a motor torque to be applied by the motor.

14. The robotic controller of claim 13, wherein the motor torque comprises a time series indicating a sequence of motor torques and for each a duration or interval through which that torque is to be applied.

15. The robotic controller of claim 1, wherein the decision comprises a change in previously determined plan to use the set of elements to perform a task.

16. The robotic controller of claim 15, wherein the change is associated with transitioning from a first state associated with a first control paradigm to a second state associated with a second control paradigm.

17. The robotic controller of claim 1, wherein the communication interface includes a physical interface to a robotic element included in the set of elements.

18. The robotic controller of claim 1, wherein the communication interface comprises a physical connector at least a portion of which conforms to a form factor and signal layout of a connector associated with a commodity controller that the robotics controller is adapted to replace.

19. A method to control a set of elements comprising a robotic system, the method comprising:
receiving at a robotic controller, via a communication interface, state information from or more elements included in the set of elements;
making at the robotic controller, based at least in part on the state information, a decision as to how to control one or more elements included in the set of elements; and
sending from the robotic controller to each of the one or more elements, via the communication interface, a command determined based on at least in part on the decision

20. A computer program product to control a set of elements comprising a robotic system, the computer program product being embodied in a non-transitory computer readable medium and comprising computer instructions for:
receiving at a robotic controller, via a communication interface, state information from or more elements included in the set of elements;
making at the robotic controller, based at least in part on the state information, a decision as to how to control one or more elements included in the set of elements; and
sending from the robotic controller to each of the one or more elements, via the communication interface, a command determined based on at least in part on the decision.
